(19) United States
(12) Patent Application Publication
(10) Pub. No.: US 2019/0251530 A1
(43) Pub. Date: Aug. 15, 2019

(54) PAYMENT SYSTEM AND METHOD OF USE

(71) Applicant: Jamal Arif, Arlington, TX (US)

(72) Inventor: Jamal Arif, Arlington, TX (US)

(21) Appl. No.: 16/271,863

(22) Filed: Feb. 10, 2019

Related U.S. Application Data
(60) Provisional application No. 62/628,995, filed on Feb. 10, 2018.

(51) Int. Cl. G06Q 20/10; G06Q 20/32; G06Q 20/28

(52) U.S. Cl. CPC G06Q 20/10; G06Q 20/28; G06Q 20/3278

(57) ABSTRACT

A payment system includes an electronic device; a platform to be accessible via the electronic device, the platform having a payment portal to allow a first user to send an electronic payment and configured to allow a second user to receive the electronic payment; and a biometric capability; an accessory having a control system with a transceiver to wirelessly communicate with the electronic device via the biometric capability of the platform, the accessory being associated with electrical components to provide access to the platform; the electronic device recognizes the accessory via the platform; and the first user anonymously transfers the electronic payment to the second user via the electronic device, platform, and accessory.

### BACKGROUND

### 1. Field of the Invention

The present invention relates generally to gratuity payment systems, and more specifically, to a payment system and method for conveniently transferring money between two parties anonymously.

### 2. Description of Related Art

Paying servers, such as valet attendants and waitstaff, is a common practice after a service has been rendered. For example, it is a common practice to tip a valet attendant as they return a vehicle.

One of the problems commonly associated with gratuity payment is a lack of cash or a lack of an appropriate cash amount. Patrons are then left without the ability to make a gratuity payment.

In addition, particularly when traveling, carrying extra cash can either pose a risk of loss or leave a person with an inappropriate currency.

Accordingly, there remains a need for a payment system to transfer electronic payments to a server or any other person while maintaining anonymity.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a payment system in accordance with a preferred embodiment of the present application;

FIG. 2 is a simplified schematic of a payment platform of FIG. 1;

FIG. 3 is a simplified schematic of a profile associated with the platform of FIG. 1; and

FIG. 4 is a flowchart of the method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional gratuity payment methods. Specifically, the present invention provides a convenient means to transmit electronic payment to a designated person while maintaining anonymity. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

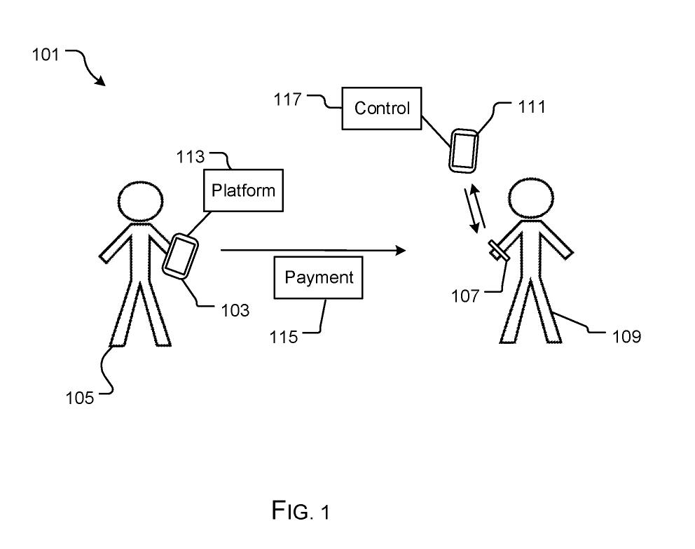

Referring now to the drawings wherein like reference characters identify corresponding or similar elements throughout the several views, FIG. 1 depicts a simplified schematic of a payment system 101 in accordance with a preferred embodiment of the present application. It will be appreciated that system 101 overcomes one or more of the above-listed problems commonly associated with conventional gratuity payment systems.

In the contemplated embodiment, system 101 includes an electronic device 103 associated with a first person 105 and an accessory 107 associated with a second person 109. In one preferred application, the first person 105 is a patron and the second person 109 is a server, such as wait staff, a valet attendant, a beauty technician, a transportation driver, or any other person providing a service for which gratuity can be paid. In alternative applications, the first and second person are acquaintances, colleagues, friends, family members, or any two people who interact.

In the preferred embodiment, accessory 107 includes the necessary electronic components, such as a power source, a transceiver, and a control system with the ability to be programmed and run algorithmic functions and configured to allow the accessory to wirelessly communicate with one or more electronic devices, including electronic device 103. It should be appreciated that this feature allows for the second person 109 to receive and exchange information between a mobile device 111 and accessory 107.

System 101 further includes a platform 113 configured to be accessed via device 103 and provide user 105 with a platform through which to designate and transmit an electronic payment 115 to second person 109. In the preferred embodiment, device 103 transmits the electronic payment via NFC connectivity between accessory 107 and device 103, however, it should be appreciated that other means could be used to achieve the same function. It must be understood that there is no transfer of personal identifying information between accessory 107 and device 103, alternatively, person 109 is assigned a unique identification configured to provide a means for the platform 113 to identify the person 109 anonymously through biometric capabilities. Platform 113 is therefore programmed to allow user 105 to transfer payment anonymously. It should be understood that this feature makes system 101 function in the same form and fashion as the transfer of cash between two parties. The payment is completed in real time and the parties cannot later determine identification of who the payment was sent from and who the payment was received by.

It should be understood that user 105 can identify person 109 via platform 113 via the unique identification, thereby providing the user 105 assurance that payment is transferred to the correct person.

In some embodiments, person 109 can access the electronic payment and monitor the payment via mobile device 111, having a control system 117. It should be appreciated that control system 117 could be incorporated into accessory 107 or accessed via a computer or other means. This feature allows for the person to track payments throughout a day or time period, such as during a serving shift, and provides for further monitoring such as an overall balance. However, it must be understood that minimal information is shown in relation to the payment, including information such as amount, time of transfer, availability of funds, but not including from whom payment was received.

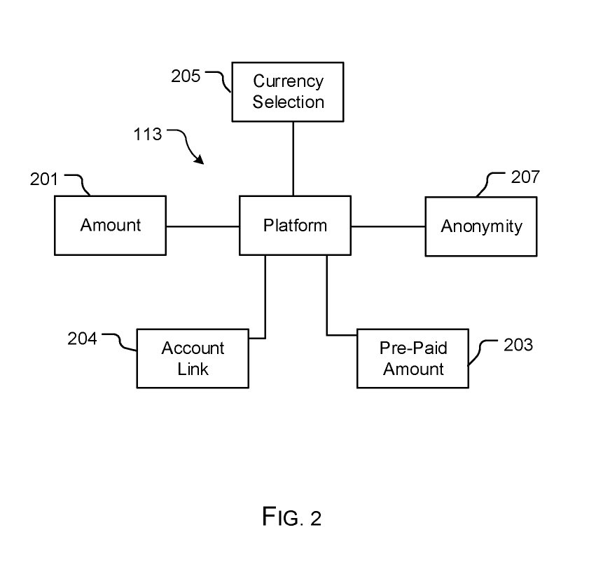

In FIG. 2, a simplified schematic shows various contemplated features of platform 113. Platform 113 provides the first person with a payment portal 201 configured to provide the person with a means to designate an amount of the electronic payment. It should be appreciated that there can be pre-determined amounts, or alternatively, platform 113 can accept customized amounts. Platform 113 can be directly linked to an account 204, such as a bank account, credit card, or debit card, thereby allowing for the user to conveniently make a payment at any time.

Platform 113 can further include a pre-paid account 203 configured to allow the user to deposit a desired amount to be used in one or more payments. In this embodiment, the person would pre-load an amount, such as one would load a gift card, thereby allowing for the person to refrain from connecting to a bank account, credit card, or debit card.

Platform 113 can further include a currency selection 205 portal configured to allow the user to designate a currency. Platform 113 is programmed to automatically translate payments made or received to the designated currency. Platform 113 is automatically programmed for anonymity 207, thereby making the payment transfer the same as cash.

It should be appreciated that one of the unique features believed characteristic of the present application is the use of an accessory to allow a first person to transmit an electronic payment to a second payment while maintaining anonymity. It should be appreciated that the accessory could be a wristband, a keychain, a necklace, or any other device. In addition, it should be appreciated that the accessory can include an emblem or various other design features for customization, such as company logos.

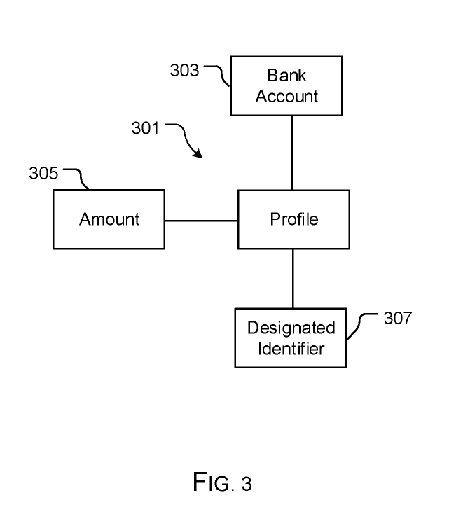

In FIG. 3, a simplified diagram demonstrates features associated with the second person's profile 301. In this example, it should be appreciated that the second person is the party receiving a payment. The second person can use platform 113 to create a profile 301, wherein the person can input customization. The user can link platform 113 to a bank account 303, thereby allowing for payments received to be automatically deposited into the account. Alternatively, the person can select to create an internal account 305, whereby payments are tracked and deposited. If this feature is selected, the person can redeem the value for a prepaid card or cash value as provided by platform 113. The person is further designated a unique identifier 307, not including personal identifying information. The unique identifier is configured to allow for the first person's electronic device to recognize the person through the platform and thereby transfer payment without receiving identifying information.

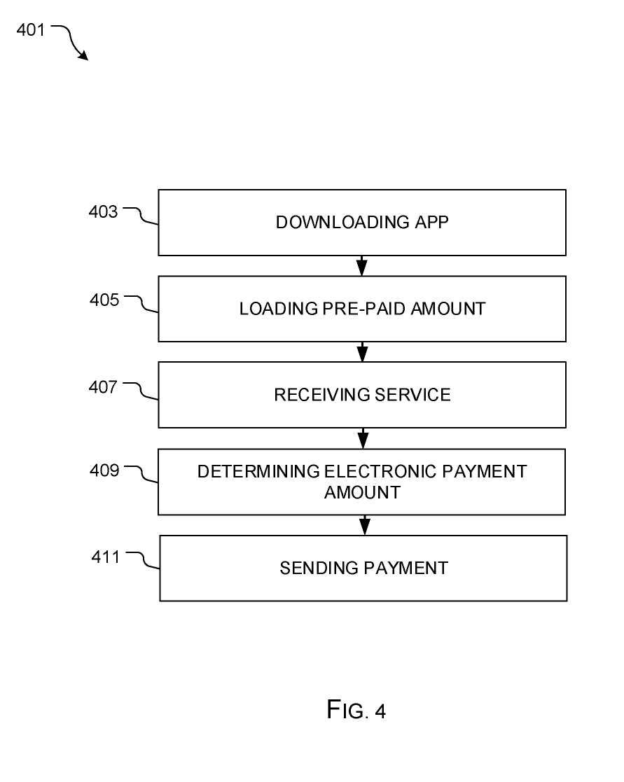

In FIG. 4, a flowchart 401 depicts the method of use of system 101. During use, the first person downloads the mobile application, thereby having access to the platform, as shown with box 403. The first person can deposit a pre-paid amount to be sent and monitored via the platform, as shown with box 405. After the first person receives service or decides they would like to transfer payment for any reason, the first person can select and send an electronic payment to the second person, as shown with boxes 407, 409, 411. It should be understood that the accessory is to be programmed to correlate to a specific second person, thereby allowing for the first person to designate the second person to send payment to via the electronic device anonymously.

It is contemplated that system 101 can include additional features. For example, platform 113 can be configured to collect data, such as usage data for use by a software and platform developer. In addition, it is contemplated that platform 113 can be correlated to a developer, wherein revenue for the developer is generated through payment transfers and/or advertising. In addition, it should be appreciated that although platform 113 is described herein between two individuals, platform 113 can be scaled through the teachings herein for various uses, such as to be used by commercial entities.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A payment system, comprising:
an electronic device;
a platform configured to be accessible via the electronic device, the platform having:
a payment portal configured to allow a first user to send an electronic payment and configured to allow a second user to receive the electronic payment; and
a biometric capability;
an accessory having a control system with a transceiver configured to wirelessly communicate with the electronic device via the biometric capability of the platform, the accessory being associated with electrical components configured to provide access to the platform;
wherein the electronic device recognizes the accessory via the platform;
wherein the platform provides identification of the accessory via a unique identifier; and
wherein the first user anonymously transfers the electronic payment to the second user via the electronic device, platform, and accessory.

2. The system of claim 1, wherein the accessory is configured to be worn on a wrist of the second user.

3. The system of claim 1, wherein the payment portal is configured to provide the first with a plurality of currency options.

4. The system of claim 1, wherein the accessory is configured to communicate with the electronic device to receive the electronic payment via NFC connectivity with the electronic device.

5. The system of claim 1, wherein the platform is configured to allow the first user to establish a pre-paid account from which the payment is withdrawn.

6. The system of claim 1, wherein the platform comprises:
a profile development portal wherein the second user can link the platform to an account.

7. The system of claim 1, wherein the accessory includes a logo displayed thereon.

8. A method of providing an anonymous payment, the method comprising:
downloading a mobile application on an electronic device, the mobile application having a payment portal through which a first user can input an electronic payment amount;
providing an accessory having a transceiver configured to wirelessly communicate with the electronic device, the accessory having a control system configured to communicate with the mobile application through anonymous means;
identifying the accessory within the mobile application via a unique identifier;
transferring the electronic payment from an account associated with a first user and linked to the platform to a second account associated with the second user and linked to the platform, the transfer being conducted anonymously; and
providing tracking of the electronic payment.
